(19) United States
(12) Patent Application Publication
(10) Pub. No.: US 2010/0090999 A1
(43) Pub. Date: Apr. 15, 2010

(54) Display device and the driving method thereof

(76) Inventor: Naoaki Komiya, Yongin-City (KR)

Correspondence Address: ROBERT E. BUSHNELL & LAW FIRM, 2029 K STREET NW, SUITE 600, WASHINGTON, DC, 20006-1004, US

(21) Appl. No.: 12/588,359

(22) Filed: Oct. 13, 2009

(30) Foreign Application Priority Data
Oct. 14, 2008 (KR) 10-2008-0100723

(51) Int. Cl. G06F 3/038; H04N 5/66

(52) U.S. Cl. 345/207; 348/739; 348/E05.133

(57) ABSTRACT

A display device and a driving method thereof. The display device detects luminance data from an input video signal, detects the amount of change of the luminance data, detects contour of an image displayed from the input video signal, and emphasizes the detected contour to generate a converted input video signal. The display device compensates the converted input video signal by comparing a data size of the converted input video signal with that of the input video signal and controlling the data size of the converted input video signal to be less than that of the input video.

### CROSS REFERENCE TO RELATED APPLICATIONS

This application makes reference to, incorporates the same herein, and claims all benefits accruing under 35 U.S.C §119 from an application entitled DISPLAY DEVICE AND DRIVING METHOD THEREOF earlier filed in the Korean Industrial Property Office on 14 Oct. 2008, which was duly assigned Serial No. 10-2008-0100723 by that Office.

### BACKGROUND OF THE INVENTION

1. Field of the Invention

The present invention relates to a display device and a driving method thereof.

2. Description of the Related Art

The weight and thickness of a display device that displays an image based on a video signal decrease according to a decrease in weight and thickness of a personal computer, a television, etc. According to a demand thereof, instead of a cathode ray tube (CRT), a flat panel type display device such as a liquid crystal display (LCD), a plasma display panel (PDP), and an organic light emitting diode (OLED) has been developed.

In such a display device, the difference between target data that display a target having a contour such as a person and background data that display a background at which the target is positioned may not be large. Accordingly, an interface of the target is included in a background so that a problem that a screen is unclearly viewed occurs. In order to solve this problem, a method of emphasizing a contour of a target such that a border between the target and a background may be clearly displayed is used.

Such a contour emphasizing method causes luminance of a contour so that the entire luminance of an image may be increased. When the entire luminance of the image increases, contrast may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device having an advantage of preventing deterioration of contour due to contour emphasis, and a driving method thereof.

A display device according to an embodiment of the present invention includes a contour emphasizing unit that detects luminance data from an input video signal, detects contour of an image displayed from the input video signal by detecting the amount of luminance data change, and generates a converted input video signal that emphasizes the detected contour, and a luminance controller that compares a data size of the converted input video signal with a data size of the input video signal and compensates the converted input video signal in order to control the data size of the converted input video signal to be less than that of the input video signal. The luminance controller includes a luminance comparing unit that compares the data size of the converted input video signal with that of the input video signal to calculate a gain for compensating the converted input video signal according to the comparison result, and a luminance compensating unit that compensates the converted input video signal according to the gain.

The contour emphasizing unit includes a luminance data detector that detects luminance data from an input video signal, a contour detector that detects contour of an image displayed from the input video signal by detecting the amount of change of the luminance data, a contour converter that converts the luminance data by increasing or decreasing the luminance data according to luminance that corresponds to the detected contour, and an adder that generates the converted input video signal by adding the input video signal that has been delayed for a predetermined time period and the converted luminance data. The amount of change of the luminance data indicates a degree of change in luminance data with respect to locations of a plurality of pixels of the display device.

The contour detector detects a first edge point where a slope of the change increases from zero to a predetermined positive value, a second edge point where the slope of the change becomes zero from the predetermined positive value, a third edge point where the slope of the change decreases to a predetermined negative value from zero, and a fourth edge point where the slope of the change becomes zero from the predetermined negative value as the contour.

The contour converter decreases luminance data corresponding to the contour that corresponds to the first and fourth edge points, and increases luminance data corresponding to the contour that corresponds to the second and third edge points.

A method for driving a display device according to another embodiment of the present invention includes detecting luminance data from an input video signal, detecting contour of an image displayed from the input video signal by detecting the amount of change of the luminance data, generating a converted input video signal that emphasizes the detected contour, and compensating the converted input video signal by comparing a data size of the converted input video signal with that of the input video signal and controlling the data size of the converted input video signal to be less than that of the input video signal.

The compensating of the converted input video signal includes comparing the data size of the converted input video signal with that of the input video signal, calculating a gain for compensating the converted input video signal according to the comparison result, and compensating the converted input video signal according to the gain. The amount of change of the luminance data indicates a degree of change in luminance data with respect to locations of a plurality of pixels of the display device.

The detecting of the contour includes a first edge point where a slope of the change increases from zero to a predetermined positive value, a second edge point where the slope of the change becomes zero from the predetermined positive value, a third edge point where the slope of the change decreases to a predetermined negative value from zero, and a fourth edge point where the slope of the change becomes zero from the predetermined negative value as the contour.

The compensating of the converted input video signal includes decreasing luminance data corresponding to the contour that corresponds to the first and fourth edge points, and increasing luminance corresponding to the contour that corresponds to the second and third edge points.

According to the exemplary embodiments of the present invention, a display device that can prevent contrast deterioration after contour emphasis, further emphasize contour compared to a conventional display device, and reduce power consumption, and a driving device thereof are provided.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a display device according to an exemplary embodiment of the present invention;

FIG. 2 is an equivalent circuit of a pixel of the display device of FIG. 1;

FIG. 3 is a schematic block diagram of a controller according to the exemplary embodiment of the present invention;

FIG. 4 shows a contour emphasizing unit according to the exemplary embodiment of the present invention; and

FIG. 5 is a waveform diagram for operation of the contour emphasizing unit according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Here, when one element is referred to as being connected to another element, one element may be not only directly connected to the another element but instead may be indirectly connected to the another element via one or more other elements. Also, when an element is referred to as being “on” another element, it can be directly on the another element or be indirectly on the another element with one or more intervening elements interposed therebetween. Further, some of the elements that are not essential to the complete description of the invention have been omitted for clarity. In addition, like reference numerals refer to like elements throughout.

In addition, unless explicitly described to the contrary, the word “comprise” and variations such as “comprises” or “comprising” will be understood to imply the inclusion of stated elements but not the exclusion of any other elements.

A display device according to an exemplary embodiment of the present invention and a driving method thereof will now be described in further detail with reference to the drawings.

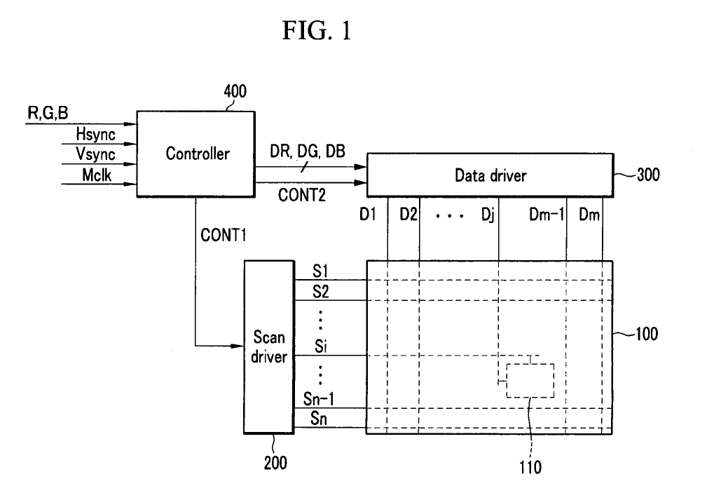

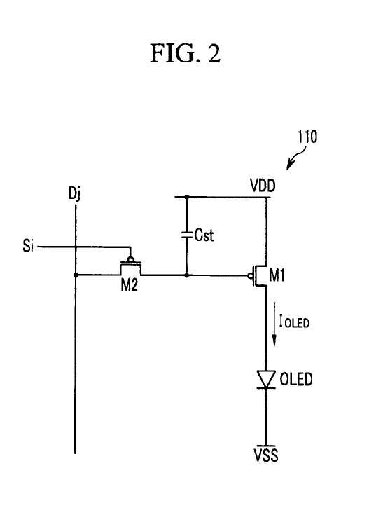

FIG. 1 is a block diagram of a display device according to an exemplary embodiment of the present invention, and FIG. 2 shows an equivalent circuit of a pixel of the display device of FIG. 1.

Referring to FIG. 1, a display device according to an exemplary embodiment of the present invention includes a display unit 100, a scan driver 200, a data driver 300, and a controller 400.

In view of an equivalent circuit, the display unit 100 includes a plurality of signal lines S1 to Sn and D1 to Dm, a plurality of voltage lines (not shown), and a plurality of pixels 110 connected to the signal lines S1 to Sn and D1 to Dm and arranged substantially in a matrix format.

The signal lines S1 to Sn and D1 to Dm include a plurality of scan lines S1 to Sn that transmit scan signals and a plurality of data lines D1 to Dm that transmit data signals. The plurality of scan lines S1 to Sn extend substantially in a row direction and are substantially parallel with each other, and the plurality of data lines D1 to Dm extend substantially in a column direction and are substantially parallel with each other. In this case, the data signal may be a voltage signal (hereinafter referred to as a data voltage) or a current signal (hereinafter referred to as a data current) according to the type of pixel 110, and the data signal in the following description will be regarded as a data voltage.

Referring to FIG. 2, each pixel 110, for example, a pixel 110 connected to the i-th (i=1, 2, . . . , n) scan line Si and the j-th (j=1, 2, . . . , m) data line Dj includes an organic light emitting element (OLED), a driving transistor M1, a storage capacitor Cst, and a switching transistor M2.

The switching transistor M2 includes a control terminal, an input terminal, and an output terminal. The control terminal is connected to the scan line Si, the input terminal is connected to the data line Dj, and the output terminal is connected to the driving transistor M1. The switching transistor M2 transmits a data signal (i.e., data voltage) applied to the data line Dj in response to a scan signal applied to the scan line Si.

The driving transistor M1 also includes a control terminal, an input terminal, and an output terminal. The control terminal is connected to the switching transistor M2, the input terminal is connected to a driving voltage VDD, and the output terminal is connected to the organic light emitting element OLED. The driving transistor M1 provides a current with a size that varies in accordance with a voltage between the control terminal and the output terminal.

The capacitor Cst is connected between the control terminal and the input terminal of the driving transistor M1. The capacitor Cst charges a data voltage applied to the control terminal of the driving transistor M1, and maintains it even after the switching transistor M2 is turned off.

The organic light emitting element OLED may be an organic light emitting diode (OLED), and includes an anode connected to the output terminal of the driving transistor M1 and a cathode connected to a common voltage VSS. The organic light emitting element OLED emits light with an intensity that changes according to the output current I_{OLED} of the driving transistor M1 to display an image.

The organic light emitting element OLED may emit light in one of three primary colors. The three primary colors exemplarily include red, green, and blue, and the three primary colors are spatially or temporally combined to obtain a desired color. In this case, the organic light emitting element OLED may partially emit white light, and accordingly luminance is increased. Alternatively, the organic light emitting elements OLEDs of all pixels 110 may emit white light, and some of the pixels 110 may further include a color filter (not shown) that changes white light emitted from the organic light emitting elements OLEDs to light in one of the primary colors.

The switching transistor M2 and the driving transistor M1 are each a p-channel field effect transistor (FET). In this case, the control terminal, the input terminal, and the output terminal respectively correspond to a gate, a source, and a drain. However, at least one of the switching transistor M2 and the driving transistor M1 may be an n-channel FET. In addition, connection between the transistors M1 and M2, the capacitor Cst, and the organic light emitting element OLED may be changed.

The pixel 110 in FIG. 2 is an exemplary pixel of the display device, and a pixel of a different type that includes at least two transistors or at least one capacitor may be used. Further, as previously described, a pixel that receives a data current as a data signal may be used.

Referring back to FIG. 1, the scan driver 200 is connected to the scan lines S1 to Sn of the display unit 100, and sequentially applies scan signals to the scan lines S1 to Sn. The scan signal is formed of combination of a gate-on voltage Von that can turn on the switching transistor M2 and a gate-off voltage Voff that can turn off the switching transistor M2. If the switching transistor M2 is the p-channel FET, the gate-on voltage Von and the gate-off voltage Voff respectively correspond to a low voltage and a high voltage.

The data driver 300 is connected to the data lines D1 to Dm of the display unit 100, converts input video signals DR, DG, and DB input from the controller 400 to a data voltage, and applies the data voltage the data lines D1 to Dm.

The controller 400 controls the scan driver 200 and the data driver 300, and externally receives input video signals R, G, and B and an input control signal for controlling the input video signals. The input video signal includes luminance information of each pixel 110, and the luminance includes a predetermined number of gray scales, for example 1024=210, 256=28, or 64=26. The input control signal exemplarily includes a horizontal synchronization signal Hsync, a vertical synchronization signal Vsync, and a main clock signal Mclk.

The controller 400 receives the input video signals R, G, and B and the input control signals Hsync, Vsync, and Mclk, converts the input video signals R, G, and B to input image data DR, DG, and DB, and generates a scan control signal CONT1 and a data control signal CONT2 by processing the input control signals.

The input control signals include a vertical synchronization signal Vsync, a horizontal synchronization signal Hsync, a main clock signal Mclk, and a data enable signal (DE, not shown). The vertical synchronization signal Vsync is a signal that informs of one frame period of the input video signal, and the horizontal synchronization signal Hsync is a signal that informs of one line period of the input video signal. The main clock signal Mclk is a clock signal for the controller 400 to convert the input video signal into the input video signal and generate an input control signal. The data enable signal DE is a signal that displays a region at which data for displaying an image is located in the input video signal.

The gate control signal CONT1 includes a scan start signal instructing to start the scanning and at least one clock signal that controls an output period of a gate-on voltage Von that turns on the switching transistor M2 of the pixel circuit. The gate control signal CONT1 may further include an output enable signal that limits the duration of the gate-on voltage Von.

The data control signal CONT2 includes a horizontal synchronization start signal that informs about a start of transmission of the video data signals DR, DG, and DB for one row of pixels 110, and a load signal and a data clock signal that indicate application of an analog data voltage to the data lines D1 to Dm.

The controller 400 transmits the scan control signal CONT1 to the scan driver 200, and transmits the data control signal CONT2 and the processed image data DR, DG, and DB to the data driver 300.

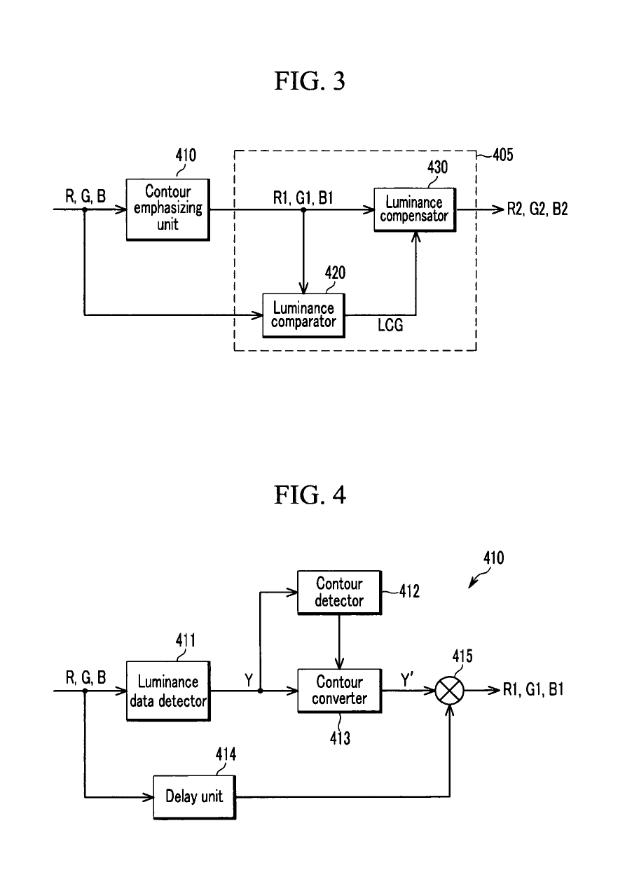

The controller 400 detects luminance data Y from the input video signals R, G, and B, detects a contour portion based on the luminance data Y, and emphasizes contour by compensating luminance data of the contour portion. The controller 400 converts the luminance data Y according to a predetermined gain for contour emphasis. The controller 400 converts the input video signals R, G, and B according to the converted luminance data Y to generate video data DR, DG, and DB. In this case, the controller 400 compares average luminance (hereinafter referred to as emphasis luminance) of contour-emphasized input video signals R1, G1, and B1 (FIG. 3) with average luminance (hereinafter referred to as input luminance) of input video signals R, G, and B before the contour emphasis, and controls the emphasis luminance to not be higher than the input luminance. The maximum ratio between the emphasis luminance and the input luminance is 1. When the entire luminance of the screen is decreased, emphasized contour appears brighter. In the exemplary embodiment of the present invention, an increase of the entire luminance of an image is suppressed through contour emphasis by using the above phenomenon to thereby further emphasize contour.

According to the data control signal CONT2 from the controller 400, the data driver 300 receives image data DR, DG, and DB for pixels in one row, converts the image data DR, DG, and DB into a data voltage, and applies the data voltage to the corresponding data lines D1 to Dm.

The scan driver 200 applies the gate-on voltage to the scan line S1 to Sn according to the scan control signal CONT1 from the controller 400 to turn on the switching transistors M2 connected to the scan lines S1 to Sn. Then, the data voltage applied to the data lines D1 to Dm is transmitted to the corresponding pixels 110 through the turned-on switching transistors M2.

The driving transistor M1 receives the data voltage through the turned-on switching transistor M2 and the organic light emitting element OLED emits light of intensity that corresponds to the output current IOLED of the driving transistor M1.

This process is repeatedly performed by the unit of one horizontal period (which may be equivalent to one period of the horizontal synchronization signal Hsync) in order to sequentially to apply the gate-on voltage to all the scan lines S1 to Sn and apply the data voltage to all the pixels 110 such that an image of one field of one frame is displayed.

Hereinafter, the controller 400 will be described with reference to FIG. 3.

FIG. 3 shows a configuration of the controller 400.

The controller 400 includes a contour emphasizing unit 410 and a luminance controller 405. The luminance controller 405 includes a luminance comparator 420 that compares emphasis luminance and input luminance to calculate a predetermined gain for compensating the emphasis luminance according to the comparison result, and a luminance compensator 430 that compensates the emphasis luminance according to the predetermined gain.

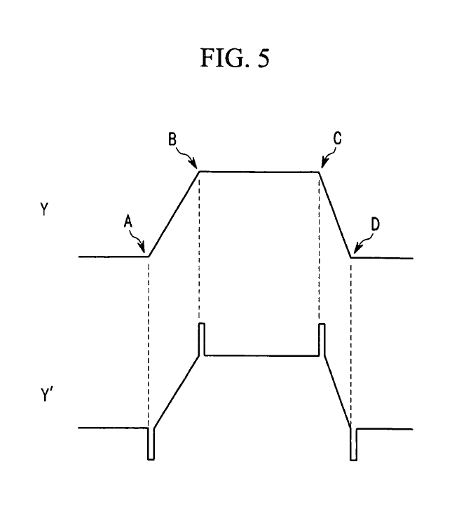

The contour emphasizing unit 410 detects luminance data Y from input video signals R, G, and B, detects a contour portion based on the luminance data, and emphasizes contour by compensating luminance data of the contour portion. The controller 400 converts the luminance data Y according to the predetermined gain for contour emphasis. The controller 400 generates converted input video signal R1, G1, and B1 that are contour-emphasized by using luminance data Y′ that is converted according to a gain, as will be later explained with respect to FIGS. 4 and 5.

The luminance comparator 420 compares a data size of the converted input video signals R1, G1, and B1 with that of the input video signals R, G, and B in order to control the data size of the converted input video signals R1, G1, and B1 to not be greater than that of the input video signals R, G, and B. The luminance comparator 420 calculates a gain LCG for controlling the data size when the data size of the converted input video signals R1, G1, and B1 is greater than that of the input video signals R, G, and B, and transmits the gain LCG to the luminance compensator 430. In further detail, in the exemplary embodiment of the present invention, the luminance comparator 420 controls the gain LCG in order to control the data size of the converted input video signals R1, G1, and B1 to have a predetermined ratio with respect to the data size of the input video signals R, G, and B.

The luminance compensator 430 compensates the converted input video signals R1, G1, and B1 according to the gain LCG to generate final video signals R2, G2, and B2 (i.e., DR, DB and DB).

Hereinafter, a contour emphasizing unit according to the exemplary embodiment of the present invention will be described with reference to FIG. 4 and FIG. 5.

FIG. 4 shows the contour emphasizing unit 410 according to the exemplary embodiment of the present invention. FIG. 5 is a waveform diagram for illustrating operation of the contour emphasizing unit 410 according to the exemplary embodiment of the present invention.

The contour emphasizing unit 410 includes a luminance data detector 411, a contour detector 412, a contour converter 413, a delay unit 414, and an adder 415.

The luminance data detector 411 detects the luminance data Y from the input video signals R, G, and B.

The contour detector 412 detects a contour portion through a slope with respect to a pixel location of the luminance data Y. That is, the contour detector 412 detects a slope that indicates the amount of change of the luminance data with respect to change of the pixel location, and determines a location where the slope is suddenly changed as contour of an image displayed by the input video signals R, G, and B. In addition, the contour detector 412 detects a location of a pixel that corresponds to the determined contour.

As shown in FIG. 5, the contour detector 412 detects edge points A, B, C, and D where the slope of the luminance data Y is suddenly changed as a contour. The edge point A is a contour where the slope of the luminance data is increased to a predetermined positive value from zero, the edge point B is a contour where the slope of the luminance data is changed to zero from the predetermined positive value, the edge point C is a contour where the slope of the luminance data is decreased to a predetermined negative value from zero, and the edge point D is a contour where the slope of the luminance data is changed to zero from the predetermined negative value.

The contour converter 413 converts the luminance data Y by increasing or decreasing the luminance data Y corresponding to the detected contour. In further detail, when luminance of the detected contour is less than reference luminance, the contour converter 413 further decreases the luminance data Y that corresponds to contour in order to emphasize low luminance of the contour. In addition, when the luminance of the detected contour is greater than the reference luminance, the contour converter 413 further increases the luminance data Y to emphasize high luminance of the contour. That is, luminance data Y corresponding to the edge points A and D are decreased, and luminance data Y corresponding to the edge points B and C are increased. The contour converter 413 transmits luminance data Y′ converted through the above process to the adder 415.

The delay unit 414 delays the input video signals R, G, and B for a predetermined time period and outputs the delayed input video signals to the adder 415. In this case, the predetermined time period is the processing period determined in accordance with a time point from which the luminance data Y is separated from the input video signals R, G, and B to a time point at which the luminance data Y is contour-emphasized and converted and then added to the adder 415.

The adder 415 adds the contour-emphasized data to the input video signals R, G, and B and outputs converted input video signals R1, G1, and B1.

As described, a contour is emphasized by using luminance data detected from input video signals, and the contour can be further emphasized by controlling emphasis luminance according to is the contour emphasis to be lower than input luminance. Further, deterioration of contrast due to increase of the entire luminance can be prevented. In addition, since luminance is lower than input luminance after the contour is emphasized, power consumption can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a contour emphasizing unit that detects luminance data from an input video signal, detects contour of an image displayed from the input video signal by detecting the amount of luminance data change, and generates a converted input video signal that emphasizes the detected contour; and
a luminance controller that compares a data size of the converted input video signal with a data size of the input video signal and compensates the converted input video signal in order to control the data size of the converted input video signal to be less than that of the input video signal.

2. The display device of claim 1, wherein the luminance controller comprises:
a luminance comparing unit that compares the data size of the converted input video signal with that of the input video signal to calculate a gain for compensating the converted input video signal according to the comparison result; and
a luminance compensating unit that compensates the converted input video signal according to the gain.

3. The display device of claim 1, wherein the contour emphasizing unit comprises:
a luminance data detector that detects luminance data from an input video signal;
a contour detector that detects contour of an image displayed from the input video signal by detecting the amount of change of the luminance data;
a contour converter that converts the luminance data by increasing or decreasing the luminance data according to luminance that corresponds to the detected contour; and
an adder that generates the converted input video signal by adding the input video signal that has been delayed for a predetermined time period and the converted luminance data.

4. The display device of claim 3, wherein the amount of change of the luminance data indicates a degree of change in luminance data with respect to locations of a plurality of pixels of the display device.

5. The display device of claim 4, wherein the contour detector detects
a first edge point where a slope of the change increases from zero to a predetermined positive value,
a second edge point where the slope of the change becomes zero from the predetermined positive value,
a third edge point where the slope of the change decreases to a predetermined negative value from zero, and
a fourth edge point where the slope of the change becomes zero from the predetermined negative value as the contour.

6. The display device of claim 5, wherein the contour converter decreases luminance data corresponding to the contour that corresponds to the first and fourth edge points, and increases luminance data corresponding to the contour that corresponds to the second and third edge points.

7. A method for driving a display device, comprising:
detecting luminance data from an input video signal;
detecting contour of an image displayed from the input video signal by detecting the amount of change of the luminance data;
generating a converted input video signal that emphasizes the detected contour; and
compensating the converted input video signal by comparing a data size of the converted input video signal with that of the input video signal and controlling the data size of the converted input video signal to be less than that of the input video signal.

8. The method of claim 7, wherein the compensating of the converted input video signal comprises:
comparing the data size of the converted input video signal with that of the input video signal, and calculating a gain for compensating the converted input video signal according to the comparison result; and
compensating the converted input video signal according to the gain.

9. The method of claim 7, wherein the amount of change of the luminance data indicates a degree of change in luminance data with respect to locations of a plurality of pixels of the display device.

10. The method of claim 9, wherein the detecting of the contour comprises detecting
a first edge point where a slope of the change increases from zero to a predetermined positive value,
a second edge point where the slope of the change becomes zero from the predetermined positive value,
a third edge point where the slope of the change decreases to a predetermined negative value from zero, and
a fourth edge point where the slope of the change becomes zero from the predetermined negative value as the contour.

11. The method of claim 10, wherein the compensating of the converted input video signal comprises decreasing luminance data corresponding to the contour that corresponds to the first and fourth edge points, and increasing luminance corresponding to the contour that corresponds to the second and third edge points.
